(19) United States
(12) Patent Application Publication
(10) Pub. No.: US 2002/0176641 A1
(43) Pub. Date: Nov. 28, 2002

(54) Shaft bearing

(75) Inventors: Frank Schmidt, Mullheim-Vogisheim (DE); Michael Schutz, Schliengen (DE); Ralf Buck, Neuenburg (DE)

Correspondence Address: KENYON & KENYON, ONE BROADWAY, NEW YORK, NY, 10004, US

(73) Assignee: Carl Freudenberg KG

(21) Appl. No.: 10/135,039

(22) Filed: Apr. 30, 2002

(30) Foreign Application Priority Data
May 28, 2001 (DE) 101 26 016.4

(51) Int. Cl. F16C 27/00

(52) U.S. Cl. 384/536

(57) ABSTRACT

A shaft bearing, which includes a roller bearing (1) having an outer ring (2) enclosed at its outer circumference by a supporting ring (3) at a radial distance, at least one first spring element (5), which is elastically yielding in the axial direction and the radial direction, being positioned in the gap (4) formed by the radial distance. Outer ring (2) is relatively non-rotatably connected to a vibration absorber (6)

### BACKGROUND OF THE INVENTION

1. Field of the Invention

The invention relates to a shaft bearing, including a roller bearing having an outer ring enclosed at its outer circumference by a supporting ring at a radial distance, at least one first spring element, which is elastically yielding in the axial and the radial direction, being positioned in the gap formed by the radial distance.

2. Description of Related Art

Such a shaft bearing is known from DE 34 46 518 A1. The supporting ring of the previously known shaft bearing is enclosed, on its part, on the outer circumference by a further outer ring at a radial distance, the gap formed by the distance being filled in at least partially by elastomer. The object to be attained by the previously known shaft bearing is seen in that noise transmission to the component connected to the shaft bearing is to be suppressed. To accomplish this, it is provided that the supporting ring can perform vibratory movements, due to its radial positioning between the first spring element and the elastomer, given the proper choice and dimensioning of the materials, which counteract the movements of the supported shaft. In this connection, it is to be observed, however, that for each application case special materials have to be newly selected and dimensioned. Only in that manner can the previously known shaft bearing be adjusted to different circumstances of vibration technology for each application case.

### SUMMARY OF THE INVENTION

It is an object of the invention to further develop a shaft bearing in such a way that the working properties of the shaft bearing may be more simply adjusted to the circumstances of vibration technology of each application case.

These and other objects of the invention are achieved by a shaft bearing, which includes a roller bearing having an outer ring which is enclosed on its outer circumference by a retaining ring at a radial distance, at least one first spring element, elastically yielding in the axial direction and the radial direction, being positioned in the gap formed by the distance, wherein the outer ring (2) is connected in a relatively non-rotatable manner to a vibration absorber (6).

### BRIEF DESCRIPTION OF THE DRAWINGS

The present invention will be described in greater detail with reference to the following drawings wherein:

FIG. 1 shows a first exemplary embodiment in which the vibration absorber is designed as a separately manufactured, ready-to-install unit, and is fastened to the outer ring of the roller bearing.

FIG. 2 shows a second exemplary embodiment in which the supporting body is formed by the outer ring, and the two spring elements are formed in one piece and of the same material.

### DETAILED DESCRIPTION OF THE INVENTION

The invention provides an elastic element which includes an outer ring which is connected relatively non-rotatably to a vibration absorber. Here it is of advantage that the shaft bearing according to the present invention may be mounted in accordance with the unit construction principle, vibration absorbers adjusted to any particular application case being able to be flange-mounted onto the outer ring of the roller bearing. By using such an embodiment, the possibility exists, in principle, of undertaking exclusively changes in the vibration absorber in connection with otherwise unchanged components, and thereby achieving the desired working properties.

The vibration absorber may have a supporting body, a second spring element and a flywheel which can vibrate essentially only in the radial direction. In contrast to torsional vibration cancelers, which are provided for reducing rotational irregularities of a combustion engine in a belt drive, the flywheel, which can only vibrate in the radial direction, absorbs radially directed vibrations which, for example, may be caused by imbalances of the shaft supported in the roller bearing or by bending vibrations of drive shafts, which are generated by high torque during power input.

It has proven especially advantageous for the axial and radial misalignment of the roller bearing to the supporting ring and for vibration absorption by the vibration absorber if the first and/or the second spring element is made of an elastomeric material.

According to a first embodiment, the vibration absorber may be designed as a separately manufactured, ready-to-install unit, which is fastened to the outer ring. Here it is of advantage that the vibration absorber can be combined with commercial Cardan shaft bearings in accordance with the unit construction principle, the shaft bearing created thereby having substantially improved working properties, in contrast to commercial Cardan shaft bearings. Because of vibration absorption in the radial direction, fatigue fractures of the supported shaft and/or damage/destruction of the roller bearing is avoided.

According to another embodiment, the supporting body of the vibration absorber may be formed by the outer ring of the roller bearing. Then the second spring element may be formed, for example, as one piece integrally formed with, and of the same material as the first spring element, and be made of an elastomeric material. In such a case, the vibration absorber forms an integral component of the shaft bearing, the shaft bearing having an overall design low in number of parts, and may also be manufactured simply and cost-effectively because of the embodiment of the two spring elements, which is one piece integrally formed and made of the same material.

The flywheel may be formed from a supporting body and an inertial mass that is non-destructively detachable from, and exchangeable with the supporting body. For this reason, the absorbing characteristic of the vibration absorber can be especially well adjusted to any particular application case. A detachable connection between supporting body and inertial mass can be made, for example, by a screw joint, the screws used forming a component part of the inertial mass.

Preferably, the shaft bearing according to the present invention is applied as a Cardan shaft bearing having a Cardan shaft absorber.

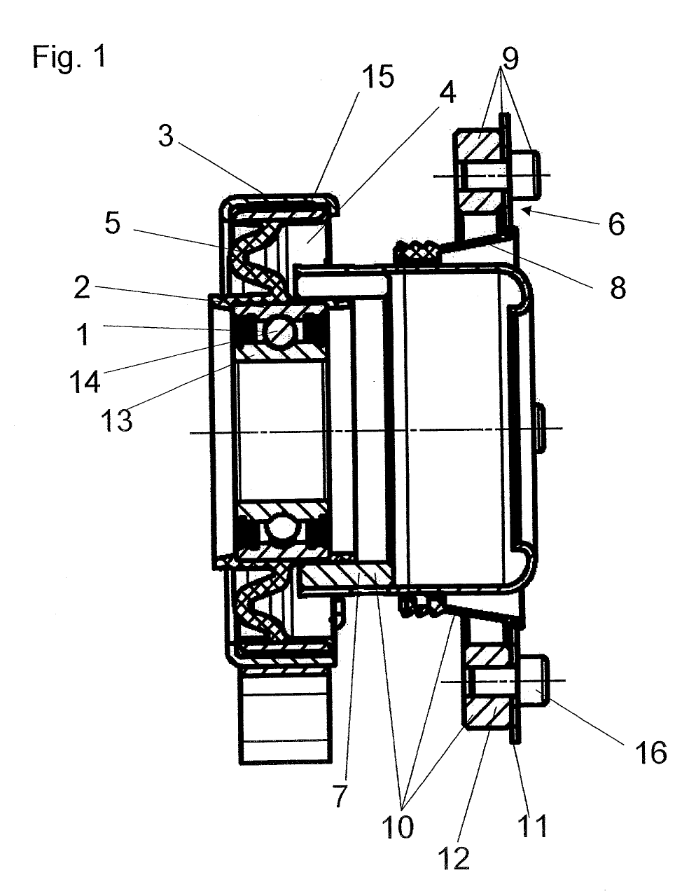

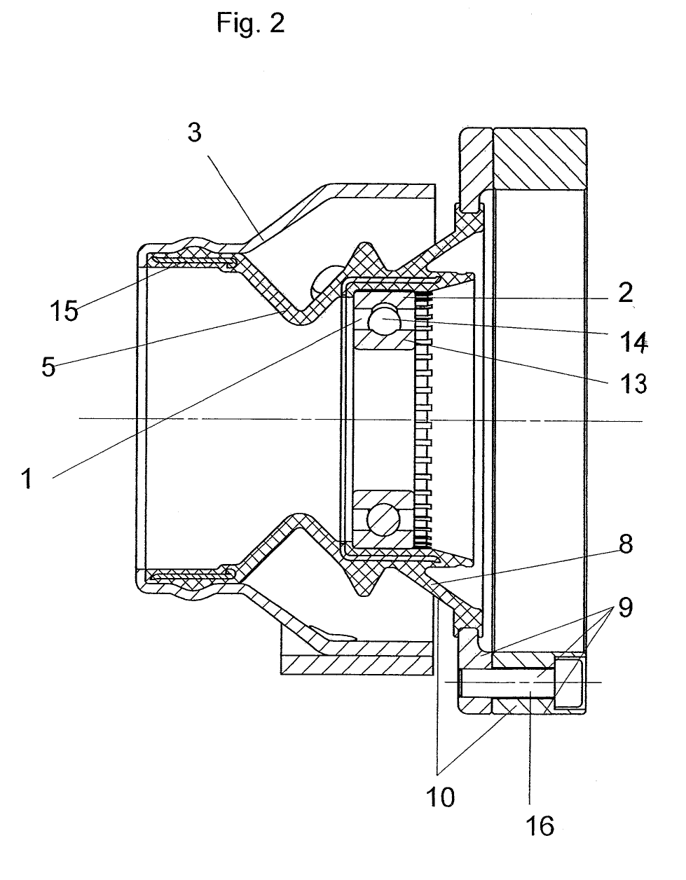

FIGS. 1 and 2 each show an exemplary embodiment of a shaft bearing according to the present invention. Each of the shaft bearings of the exemplary embodiments is executed as a Cardan shaft bearing for a motor vehicle. The shaft bearings shown each include a roller bearing 1, which is designed as a sealed grooved ball bearing in these exemplary embodiments. The roller bearing 1 includes an outer ring 2 and an inner ring 13, outer ring 2 and inner ring 13 being supported on each other by rolling elements 14 which are usually contained in a cage. In the exemplary embodiments shown here, as seen in longitudinal section, first spring element 5 is formed by a circular peripheral V-shaped fold, open axially in the direction of vibration absorber 6, first spring element 5 being made of a rubber-elastic, elastomeric material. Radially on the outside, first spring element 5 has a supporting ring 15, which is completely enclosed by the elastomeric material of first spring element 5, supporting ring 15 effecting a simplified fixing of first spring element 5 to retaining ring 3. On the outer circumference of outer ring 2 first spring element 5 is directly vulcanized on or clipped on.

Because of the V-shaped fold of first spring element 5, roller bearing 1 may be deflected both in the radial and in the axial direction with reference to retaining ring 3, without service life-reducing tensile and/or shear stresses being created within first spring element 5. First spring element 5 therefore exhibits uniformly good working properties during a long service life.

In both exemplary embodiments, outer ring 2 is connected relatively non-rotatably with vibration absorber 6, flywheel 9 of vibration absorber 6 being able to vibrate essentially only in the radial direction.

In FIG. 1, vibration absorber 6 forms a separately manufactured, ready-to-install unit 10, which is made up of supporting body 7, second spring element 8 and flywheel 9. This ready-to-install unit 10 is pressed onto the outer circumference of outer ring 2, and is thereby rotatably fixed to it.

In contrast, in FIG. 2, supporting body 7 of vibration absorber 6 is formed by outer ring 2 of roller bearing 1, so that the shaft bearing, all in all, has a design using few parts. In addition, second spring element 8 is formed in one piece integrally formed with first spring element 5, second spring element 8 and first spring element 5 being made of the same elastomeric material. Because of the design of the shaft bearing shown in FIG. 2 using few parts, it is comparatively simple and cost-effective to manufacture and has only a low mass.

Both in the exemplary embodiment of FIG. 1 and in exemplary embodiment of FIG. 2, flywheel 9 is made of two parts. Flywheel 9 is made of supporting body 11 and inertial mass 12, which are connected to each other non-destructively detachable and interchangeably. The interchangeability is ensured by fastening means 16, which form a component part of flywheel 9, and are designed as screws in this exemplary embodiment. The screws are positioned uniformly distributed in the circumferential direction.

If, for example, only a very small flywheel 9 is required, the possibility exists of removing both inertial mass 12 and fastening means 16, so that only comparatively light supporting body 11 still functions as a flywheel. On the other hand, if a relatively enlarged flywheel 9 is required, various weights of inertial masses 12 may be connected to supporting body 11, so that, for example, even if the shaft bearing is made as in FIG. 2, and supporting body 7 is formed by outer ring 2, and the two spring elements 5, 8 are made in one piece, the working properties of the vibration absorber are easy to adjust to each application case. One and the same shaft bearing can then be used for various application cases with the exception of the different weights of inertial masses 9.

What is claimed is:

1. A shaft bearing, comprising: a roller bearing having an outer ring which is enclosed on its outer circumference by a retaining ring at a radial distance, at least one first spring element, elastically yielding in the axial direction and the radial direction, being positioned in the gap formed by the distance, wherein the outer ring (2) is connected in a relatively non-rotatable manner to a vibration absorber (6).

2. The shaft bearing according to claim 1, wherein the vibration absorber (6) has a supporting body (7), a second spring element (8) and a flywheel (9) capable of vibrating essentially only in the radial direction.

3. The shaft bearing according to claim 1, wherein the first spring element (5) or the second spring element (8) are made of elastomeric material.

4. The shaft bearing according to claim 2, wherein the first spring element (5) and/or the second spring element (8) are made of elastomeric material.

5. The shaft bearing according to claim 1, wherein the vibration absorber (6) forms a separately manufactured, ready-to-install unit (10) which is fastened to the outer ring (2).

6. The shaft bearing according to claim 2, wherein the vibration absorber (6) forms a separately manufactured, ready-to-install unit (10) which is fastened to the outer ring (2).

7. The shaft bearing according to claim 3, wherein the vibration absorber (6) forms a separately manufactured, ready-to-install unit (10) which is fastened to the outer ring (2).

8. The shaft bearing according to claim 1, wherein the supporting body (7) is formed by the outer ring (2).

9. The shaft bearing according to claim 2, wherein the supporting body (7) is formed by the outer ring (2).

10. The shaft bearing according to claim 3, wherein the supporting body (7) is formed by the outer ring (2).

11. The shaft bearing according to claim 9, wherein the second spring element (8) is configured of the same material, integrally and continuously with the first spring element (5), and is made of elastomeric material.

12. The shaft bearing according to claim 1, which includes a flywheel (9) formed by a supporting body (11) and an inertial mass (12) connected in a manner that it can be detached and interchanged non-destructively with the supporting body (11).
